(19) United States
(12) Patent Application Publication
(10) Pub. No.: US 2010/0102556 A1
(43) Pub. Date: Apr. 29, 2010

(54) Pipe stop system and method to prevent over insertion

(75) Inventor: Sebastien Gauthier, La Prairie (CA)

Correspondence Address: RICHES, MCKENZIE & HERBERT, LLP, SUITE 1800, 2 BLOOR STREET EAST, TORONTO, ON, M4W 3J5, CA

(73) Assignee: Ipex Inc.

(21) Appl. No.: 12/289,366

(22) Filed: Oct. 27, 2008

(51) Int. Cl. F16L 21/00; B29C 47/06

(52) U.S. Cl. 285/399; 264/514

(57) ABSTRACT

A bell end in an extruded pipe having a transition phase of greater than 35° is formed by thermoforming. The transition phase acts as a pipe stop system to prevent over insertion of another pipe into the bell end. The process includes heating the first end of the pipe, pushing the pipe onto a mandrel having a sloped portion with a forming angle of more than 35° and applying pressure to conform the pipe to the shape of the working surface of the mandrel. The heating step includes heating an end of the pipe where the transition phase will be formed in a preliminary pre-heater, while the pipe is still warm from the extrusion process, and then immediately thereafter in a heating box. Preferably, the end of the pipe, and in particular the portion of the pipe corresponding to the longitudinal position where the transition phase will be formed, will be heated to an average temperature of at least 100° F. and more preferably 200° F. and still more preferably at 300° F. The number of heating zones in the heating unit and the duration of heating is selected to be comparable to the time required to extrude the pipe so that the overall thermoforming process can be performed substantially continuously with the pipe extrusion.

### FIELD OF THE INVENTION

This invention relates to the field of pipe joints. In particular, this invention relates to the field of manufacturing pipe joints and, in particular, the bell end for use in a pipe joint.

### BACKGROUND OF THE INVENTION

It is well known in the art that to extrude plastic pipes in an elongated cylindrical configuration of a desired diameter and then to cut the extruded pipe into individual lengths. Generally, the individual lengths are conveniently sized and suitable for handling, shipping and eventual installation at a location generally distant from the location where the plastic pipes are extruded. Each length of pipe is enlarged or “belled” at one end sufficiently to receive the adjacent next pipe section in order to create a pipe joint. The “belled” end of the pipe is thus enlarged to have a diameter larger than the diameter of the extruded pipe in order to receive the “spigot” end of the next adjacent pipe length. Generally, the larger inside diameter of the bell is formed sufficiently large to receive the spigot end of the next section of pipe with sufficient clearance to allow the application of packing, caulking, elastomeric gaskets or other sealing devices designed to prevent leakage of pipe joints.

In general, the bell end will have a transition phase where the bell transitions from the large diameter sufficient to receive the spigot end, to the standard diameter of the pipe as it was when it was originally extruded. This transition phase also acts as a pipe stop to prevent further insertion of the spigot end of the adjacent pipe. At present, bell ends have been created with the transition phase of generally 15° to 30°. This has been done for a number of reasons. One reason includes the fact that the bell ends have been formed using thermoforming. Thermoforming involves heating an extruded pipe in order to cause the pipe to become more elastic permitting it to be formed about a mandrel generally to have a different shape. It is generally difficult to form a transition phase of greater than 30° with thermoforming.

However, the prior art devices with the transition phase of 15° to 30° run the risk that the spigot or male end can be inserted past the transition phase in the belled end of the external pipe. This induces “hoop tensile stresses” in the external pipe. These types of stresses could result in pipe failure.

While it is known to have pipes with transition phases greater than 30°, such pipes are made from processes which are much more costly than thermoforming. Such processes include forming the pipe by casting, which is generally much more expensive because the entire pipe must be placed in a cast, or, a fitting must be cast for the end of the pipe. Other bell forming processes have included making pipes of thicker diameter and then machining a transition phase, such as by grinding, grooving or welding the pipe. The difficulty with this approach is that much more material is used for the pipe along the entire length in order to have a diameter at the bell end sufficient to permit machining of this type increasing the overall cost of the entire piping system. Furthermore, these processes tend to be much more expensive, both in the term of labour and time than thermoforming. Furthermore, these processes tend to require initial costs to implement the processes, such as for the equipment and/or the forms to cast the parts.

Accordingly, there is a need in the art for a pipe stop system having a bell end with a transition phase of greater than 30° that is not manufactured by machining or molding. There is also a need in the art for a method to manufacture a bell end having a transition range that decreases hoop tensile stresses, but which can be economically used on extruded pipe with a minimum of cost due to labour or additional materials.

### SUMMARY OF THE INVENTION

Accordingly, it is an object of this invention to at least partially overcome some of the disadvantages of the prior art. Also, it is an object of this invention to provide an improved type of pipe joint having a bell end with a transition phase having a transition angle of preferably greater than 35° and more preferably greater than 45°. It is also an object of this invention to provide a method for forming a transition phase in the bell end with a transition angle of preferably greater than 55° and more preferably about 60°.

Accordingly, in one of its aspects, this invention resides in a process for thermoforming a bell end in an extruded thermoplastic pipe, said bell end having a transition angle at a transition phase of greater than 35° with respect to a longitudinal axis of the pipe, said process comprising: heating a first end of the extruded pipe; after heating, pushing the first end onto a mandrel, said mandrel extending along a longitudinal axis and having a working surface, said working surface having a first portion with an outer diameter corresponding to the inner diameter of the extruded pipe, a second portion having an outer diameter corresponding to the outer diameter of the extruded pipe, and a sloped portion intermediate the first portion and the second portion, said slope portion having at least one forming angle greater than 35°, said first end being initially pushed onto the first portion; after the first end has been fully pushed onto the mandrel, conforming the first end to the working surface of the mandrel; and after the first end has been cooled, removing the first end from the mandrel.

In a further of its aspects, this invention resides in a process for thermoforming a bell end with a transition phase of greater than 35° in an extruded thermoplastic pipe having a length, said process comprising: heating a first end of the extruded pipe; after heating, pushing the first end onto a mandrel in a first direction, said mandrel extending along a longitudinal axis and having a working surface with at least one forming angle greater than 35° with respect to the longitudinal axis and increasing an outer diameter of the mandrel in the first direction; after the first end has been fully pushed onto the mandrel, applying pressure to an outer surface of the first end to conform the first end to the working surface of the mandrel; and after cooling of the first end, removing the first end from the mandrel.

Accordingly, one advantage of the present invention is that the transition phase has a transition angle which is more than 35°, and more preferably will be greater than 45°, and still more preferably greater than 55°. In a preferred embodiment, the transition phase will have a transition angle of about 60°. It is understood that the transition angle of about 60° may not be consistent on the inside and outside of the pipe. For instance, with the transition phase of about 60°, the inner angle may be about 57°. Reference to the transition angle generally refers to the angle on the inside of the pipe.

It has been appreciated that by changing the angle of the transition phase from 30° to 60°, the radial resultant forces into the belled end of the external pipe are reduced substantially, such as by up to 40%, when inserting the spigot end. Furthermore, it has been appreciated that by increasing the transition phase from 30° to 60°, the radial stresses, also referred to as the hoop stresses, may be reduced by almost 50%. By reducing the resultant forces and radial stresses by about 40% and about 50%, respectively, the instances of failure of the pipe in the field can be greatly reduced. Accordingly, an improved pipe stop system to prevent over-insertion of the spigot end can be provided.

It is also understood that pipes will have maximum insertion lines indicating the length beyond which the spigot end should not be inserted. However, it is not rare that this maximum insertion line is not respected for a number of different reasons which will result in pipes being over-inserted thereby creating the hoop tensile stresses referred to above. The present invention provides an advantage over the prior art by reducing the radial resultant forces and the radial stresses even if the maximum insertion line is not respected. It is also understood that during installation, pipes may be compressed for a number of reasons. In such instances, even if the maximum insertion line is respected when the pipes are initially joined, later stresses may arise during installation. Accordingly, the present invention also provides advantages by removing resultant forces and radial stresses during insertion and installation.

It is also understood that the present invention can work with any type of thermoplastic extrusion pipe. However, it has been appreciated that in a preferred embodiment the present invention will operate particularly well with polyvinyl chloride (PVC) pipes.

Further aspects of the invention will become apparent upon reading the following detailed description and drawings, which illustrate the invention and preferred embodiments of the invention.

### BRIEF DESCRIPTION OF THE DRAWINGS

In the drawings, which illustrate embodiments of the invention:

FIG. 1 is an overview of the pipe joint between a first pipe and a second pipe.

FIG. 2 is an enlarged detailed view of the resultant forces in an intersection of the spigot end of the first pipe inserted in to the bell end of the second pipe shown in FIG. 1, where the bell end has a 30° transition phase according to the prior art.

FIG. 3 is an enlarged detailed view of the resultant forces in an intersection of the spigot end of the first pipe inserted in to the bell end of the second pipe shown in FIG. 1, where the bell end has a 60° transition phase according to one embodiment of the present invention.

FIG. 4 illustrates the steps in the process for forming a pipe according to one preferred embodiment of the invention.

FIG. 5A is a front view of the mandrel according to one embodiment of the present invention.

FIG. 5B is a side view of the mandrel according to one embodiment of the present invention.

FIG. 6 shows a preheater in the down or closed position around a pipe on a conveyor.

FIG. 7 shows a side view of a zone in a heating box according to one embodiment of the present invention.

FIG. 8 shows a top view of the heating box in FIG. 7 showing zones 1 and zones 2.

FIG. 9 is a schematic diagram showing a plurality of heating rods within a pipe when the pipe is in the inserted position of a heating zone according to one embodiment of the present invention.

FIGS. 10A, 10 B and 10C is a cross-section showing the heated pipe being pushed onto the mandrel according to one embodiment of the present invention.

FIG. 11 is a cross-section showing the pipe being conformed to the mandrel according to one preferred embodiment where pressure is applied to the outside of the pipe.

FIG. 12 is a cross-section of cold water being sprayed on the outside surface of the pipe according to one preferred embodiment of the present invention.

FIG. 13 illustrates the knuckles forming the gasket groove being collapsed after the pipe has been conformed to the shape of the mandrel.

FIG. 14 is a cross-section illustrating the removal of the pipe from the mandrel.

### DETAILED DESCRIPTION OF THE PREFERRED EMBODIMENTS

Preferred embodiments of the invention and its advantages can be understood by referring to the present drawings. In the present drawings, like numerals are used for like and corresponding parts of the accompanying drawings.

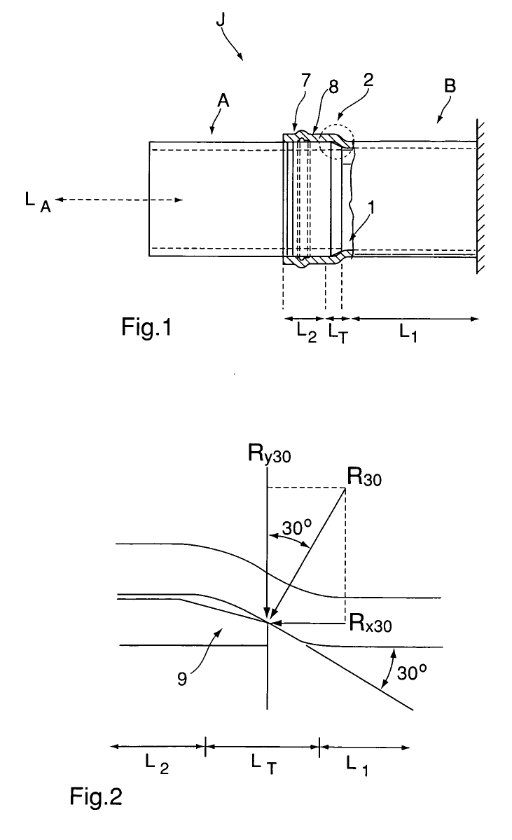

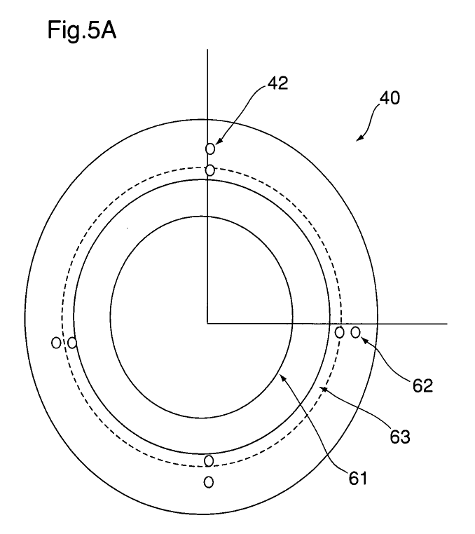

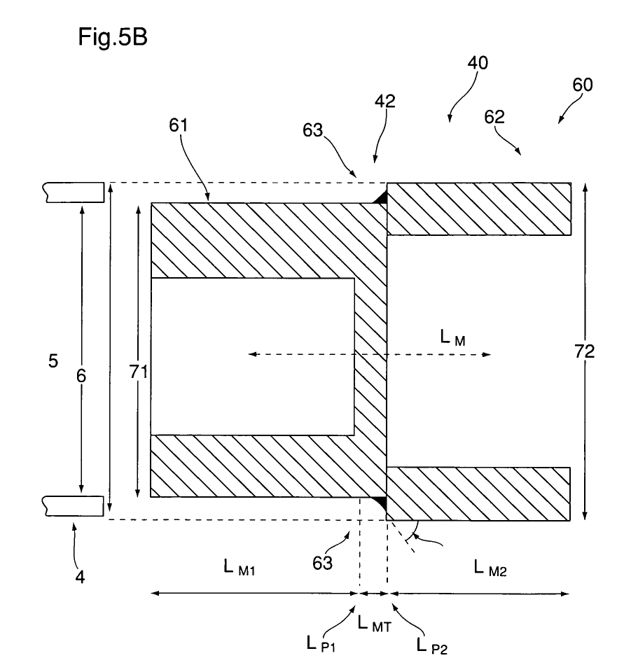

FIG. 1 illustrates an overview of a pipe joint J between a first pipe A and a second pipe B. The first pipe A has a spigot end 1 which fits into the bell end 2 of pipe B. The first pipe A and the second pipe B will be aligned along a longitudinal axis L_{A}. The bell end 2 of pipe B may also have a groove 8 for a gasket (not shown). The bell end 2 of the pipe B will also have a transition phase, shown generally by reference numeral L_{T}, which will have a transition angle α with respect to the longitudinal axis L_{A}. The transition angle α and the transition phase L_{T} separate the first length L₁ from the second length L₂ of the pipe B. The first length L₁ will have an outer diameter 6 (see FIG. 5B), which will be substantially the same as the outer diameter of pipe A. At the second length L₂, the bell end 2 will have an inner diameter 5 which is comparable to the outer diameter of pipe A so as to permit pipe A to fit into pipe B thereby forming the joint J. The transition angle α of the transition phase L_{T} will transition from the first length L₁ having the outer diameter 6 comparable to the outer diameter of the pipe A, to the second length L₂ having an inner diameter 5 of pipe B comparable to the outer diameter 6 of pipe A to receive the spigot end 1 in the bell end 2. It is understood that generally both pipes A and B will be extruded in the same manner and the bell end 2 will be thermoformed on pipe B. While not shown in FIG. 1, it is understood that the other end of pipe A may also have a bell end (not shown) thermoformed thereon so as to form a further joint (not shown) with a further pipe (not shown). The spigot end 1 of the first pipe A may also have a chamfered edge 9 as is known in the art.

It is not uncommon for the spigot end A to have a maximum insertion line, shown generally by reference numeral 7. However, it is also not uncommon that this maximum insertion line 7 is ignored for different reasons, such that the pipe A is over-inserted into the pipe B creating stresses that can lead to failure. In fact, the chamfer 9 of the socket end 1 may come into contact with the transition phase L_{T} as best illustrated in FIG. 2, which is a detailed view illustrating the resulting forces at the intersection of the first pipe A inserted into the second pipe B.

FIG. 2 illustrates the resultant forces on the bell end 1 of pipe B, which has a transition angle α of 30° as is known in the prior art when pipe A is over-inserted into pipe B. As illustrated in FIG. 2, the force vector R₃₀ has a large vertical or radial component, represented by reference symbol R_{y30} and a smaller axial component represented by reference symbol Rₓ₃₀ which acts horizontally and therefore into the pipe B. It is understood that the axial force Rₓ₃₀ can be absorbed relatively easily by pipe B and the pipe system in general does not overly stress the pipe B. In contrast, the radial or vertical force component R_{y30} may cause radial stresses and hoop stresses on pipe B which can adversely affect the pipe B and lead to pipe failure.

To prevent adverse effects caused by the over-insertion of the pipe A into the bell end 2 of the pipe B it is preferred if the transition phase L_{T} have a transition angle α with respect to the longitudinal axis L_{A} of at least 35°.

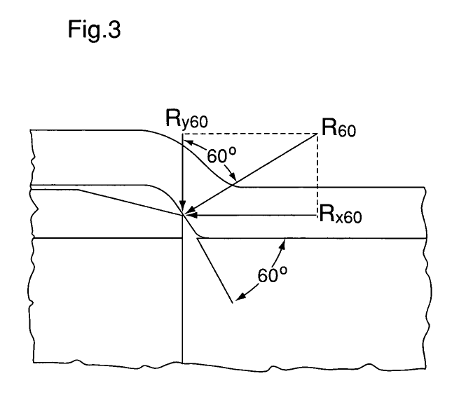

This is illustrated, for instance, in FIG. 3, which is a large detailed view of the resulting forces at an intersection of a first pipe A inserted into a second pipe B where the bell end 2 has a 60° transition angle α at the transition phase L_{T} according to one embodiment of the present invention. As illustrated in FIG. 3, the over-insertion of pipe A into pipe B will cause a resultant force vector, illustrated by reference symbol R₆₀, having a component radial force R_{y60} and a component axial force Rₓ₆₀. As is apparent from FIG. 3, when the transition phase L_{T} has a transition angle α of 60°, the axial force Rₓ₆₀, which can be more easily absorbed by the pipe B, is much greater than the radial force R_{y60}. In this way, radial stresses on the “shoulder” or transition phase L_{T} of the bell 2 of the pipe B is lessened and the over-insertion forces R₆₀ are dissipated as a compressive force on the pipe B. Accordingly, by changing the transition angle α from 30° to the longitudinal axis L_{A} of the pipe B, to 60° to the longitudinal axis L_{A} of the pipe B, the radial tension in the joint J between pipe A and pipe B is greatly reduced. In addition, the greater component of over-insertion force is transferred from the radial direction R_{y60} to the axial direction Rₓ₆₀ of the pipe B along its longitudinal axis L_{A}, and, thereby is more easily absorbed.

It would appreciated that an “ideal” transition angle α of 90° will eliminate the entire radial resultant force. However, even transition angles α of greater than 35° have been found to decrease most of the destructive radial component forces R_{y}.

In order to thermoform a transition phase a of greater than 35° in a pipe 4, a mandrel 40, as shown in FIGS. 5A and 5B may be used. The mandrel 40 has, in a preferred embodiment, holes 42 at various locations to permit air to be removed. The air can be removed either by suction or by applying pressure to the outside of the mandrel. In a preferred embodiment, suction is not applied, but rather the holes 42 communicate with the atmosphere and are present to avoid air being trapped between the mandrel 40 and the pipe 4, so as to form a transition angle α in the pipe 4 greater than 35°. FIG. 5A shows eight holes 42, as shown at 90° intervals around the mandrel 40. It is understood that this is simply one embodiment. In a preferred embodiment, 16 holes 42 may be present at 45° intervals around the mandrel 40. The number of holes 42 may also be increased if larger diameter pipe B is used to facilitate removal of trapped air.

The mandrel 40 also, preferably, has a working surface, shown generally by reference numeral 60. With reference to FIGS. 5A and 5B, it is apparent that the first portion 61 of the working surface 60 has a first outer diameter 71, which corresponds to the inner diameter 5 of an extruded pipe 4, as illustrated in FIG. 5A. The second portion 62 of the working surface 60 has an outer diameter 72 corresponding to the outer diameter 6 of the extruded pipe 4. Intermediate the first portion 61 and the second portion 62 of the working surface 60 is a sloped portion 63. The sloped portion 63 has at least one forming angle β as best illustrated in FIG. 5B. The at least one forming angle β is preferably at least 35° with respect to the longitudinal axis L_{M} of the mandrel 40. More preferably, the at least one forming angle β is greater than 45° with respect to the longitudinal axis L_{M} of the mandrel 40. In a further preferred embodiment, the at least one forming angle β is greater than 55° with respect to the longitudinal axis L_{M}. In a still further preferred embodiment, the at least one forming angle β is about 60° with respect to the longitudinal axis L_{M} of the mandrel 40. It is understood, however, that it is preferred that the at least one forming angle β is no greater than 90° with respect to the longitudinal axis L_{M} of the mandrel 40.

Furthermore, in a preferred embodiment, the sloped portion 63 of the working surface 60 intersects the first portion 61 at a first longitudinal position L_{P1} along the longitudinal axis L_{M} of the mandrel 40 and the sloped portion 63 intersects the second portion 63 at a second longitudinal position L_{P2} along the longitudinal axis L_{M} of the mandrel 40. The sloped portion 63 is preferably sloped with respect to the longitudinal axis L_{M} with the at least one forming angle β from the first longitudinal position L_{P1} to the second longitudinal position L_{P2}. In this way, the sloped portion 63 has a generally inclined surface at the sloped angle β with respect to the longitudinal axis L_{M}. In other words, the working surface 60 preferably is inclined at the sloped angle β with respect to the longitudinal axis L_{M} over the sloped portion 63 corresponding to the axial position of the transition phase L_{MT} along the axis L of the mandrel 40.

As illustrated in FIG. 5B, the first end 11 of the pipe 4 will be initially pushed onto the first portion 61. Because the outer diameter 71 of the first portion 61 corresponds to the inner diameter 5 of the extruded pipe 4, not a great deal of force will be required at this initial stage. Afterwards, the pipe 4 will be continued to be pushed onto the sloped portion 63 and then the second portion 62.

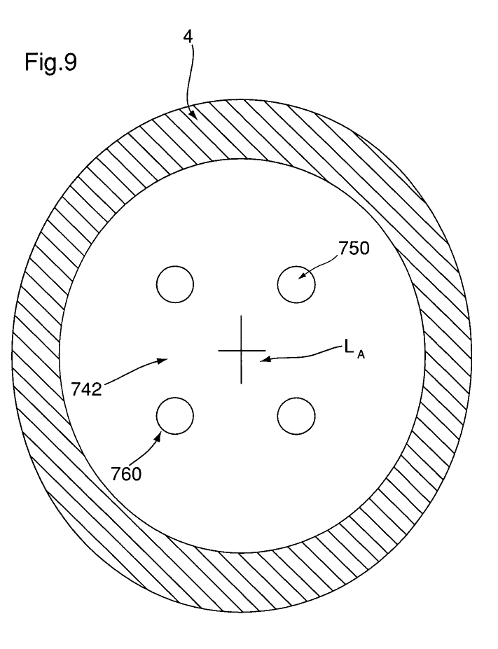

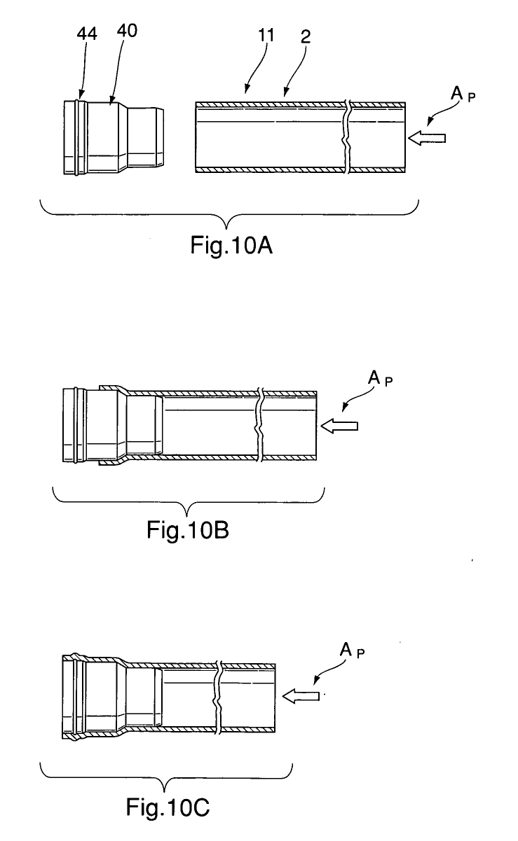

This is illustrated in FIGS. 10A, 10B and 10C, which show the first end 11 of the pipe 4 being pushed, shown by arrow A_{P} onto the mandrel 40. The mandrel 40, as illustrated in FIGS. 10A, 10B and 10C extends along a longitudinal axis L as also discussed with respect to FIGS. 5A and 5B. In FIG. 10B, the pipe 4 is shown being pushed onto the second portion L_{M2} of the working surface 60 of the mandrel 40 and with a portion of the first end 11 of the pipe over the sloped portion L_{MT} intermediate the first portion L_{M1} and the second portion L_{M2} of the working surface 60 of the mandrel 40. As illustrated in FIGS. 10A, 10B and 10C, the forming angle β of the mandrel 40 is greater than 35° and in this preferred embodiment the forming angle β is 60°. The pipe 4 may be pushed onto the mandrel 40 in any known manner. It is understood that the pipe 4 would generally be heated before it is pushed onto the mandrel as discussed more fully below. In FIG. 10C, the pipe 4 is shown as being fully inserted onto the mandrel 40 with the first end 11 past the sloped portion 63 and also past the retractable knuckles 40. It is understood that preferably the retractable knuckles 40 are in the extended position when the pipe 4 is inserted onto the mandrel 40. The retractable knuckles 44 will eventually be retracted to permit stripping of the pipe 4 from the mandrel, as discussed below, and to leave space to accommodate a gasket (not shown).

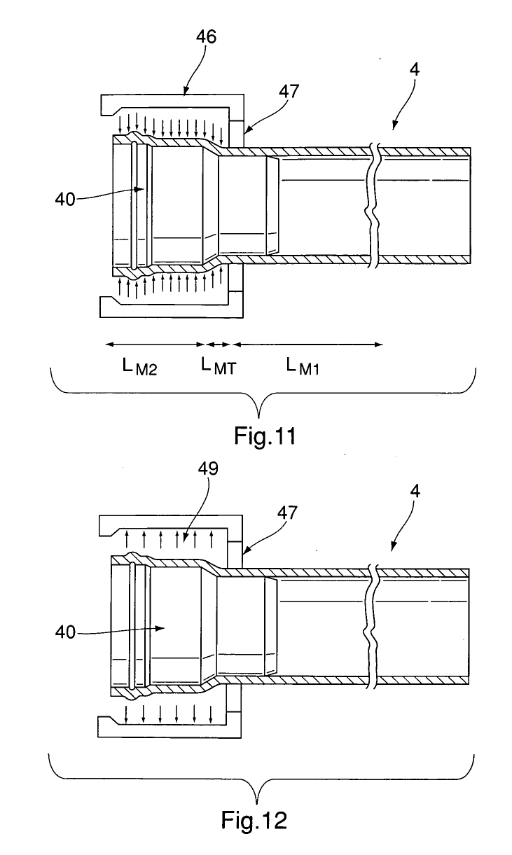

After the first end 11 has been fully pushed onto the mandrel 40, the first end 11 is conformed to a profile substantially corresponding to the working surface 60 of the mandrel 40. This can be done in a number of ways, such as applying pressure to the outside of the pipe 4. Pressure can be applied either by air pressure or by physical pressure. This is illustrated, for instance, in FIG. 11, which shows a pressure chamber 46 with clamps 47 engaging over the pipe 4 at an axial position corresponding to the first portion L_{M1} of the mandrel 40. Air pressure can then be applied within the pressure chamber 46 to conform the first end 11 to the working surface 60 of the mandrel 40. The air pressure is preferably applied at a pressure greater than 100 PSI and more preferably between 100 and 120 PSI

As indicated above, air holes 42 may be present in the mandrel 40 to avoid air becoming trapped between the pipe 4 and the mandrel 40, particularly along the sloped portion L_{MT}. As illustrated in FIGS. 5A and 5B, in a preferred embodiment, the holes 42 are located at the transition phase L_{MT}. In a preferred embodiment, it is preferred that the breathing holes 42 are circumferentially located at a longitudinal location along the mandrel axis L_{M} near the intersection of the transition phase L_{MT} and the first portion L_{M1}. Preferably, circumferential breathing holes 42 are also located near the intersection of the transition phase L_{MT} and the second portion L_{M2} of the mandrel 40.

In the further preferred embodiment, as illustrated in FIG. 12, water jets spray water, shown by reference numeral 49, onto the outside surface of the pipe 4. This has a purpose of cooling the pipe 4 and essentially “freezing” the pipe 4 into a profile corresponding substantially to the shape of the working surface 60 of the mandrel 40.

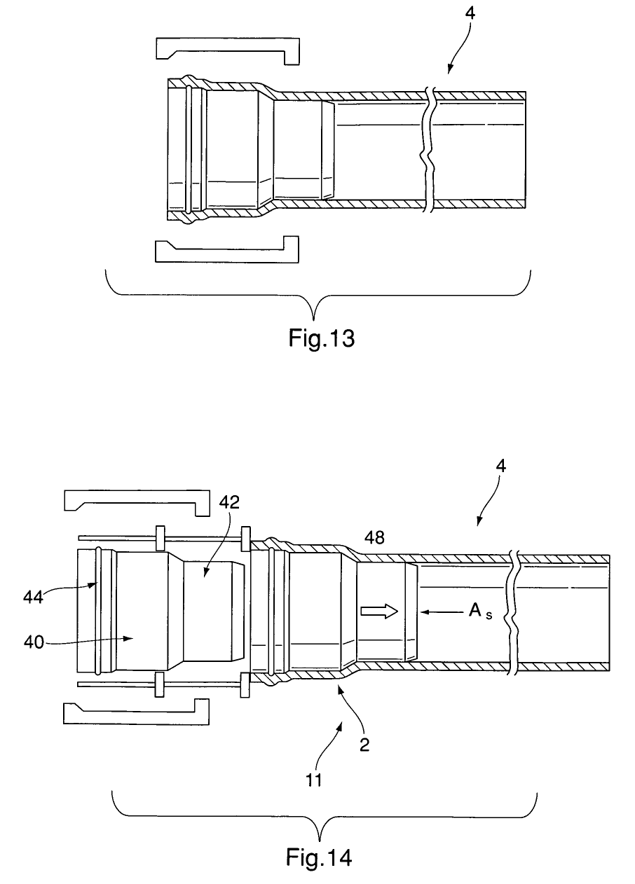

FIG. 13 illustrates the pressure chamber 46 being removed or declamped from the pipe 4 after the pipe has been cooled. The pipe 4 may now be removed from the mandrel 40, as illustrated in FIG. 14, which shows the retractable knuckles 44 being retracted and stripper ring 40 stripping the pipe 4 from the mandrel 40 which also exposes the plurality of holes 42. It is understood that the holes 42 may also assist with stripping the pipe 4 by avoiding the creation of a suction between the mandrel 40 and the pipe 4. The stripper ring 48 strips the pipe 4 off the mandrel 40 in a direction A_{S} which is opposite to the direction A_{P} shown in FIG. 10. The pipe 4 may now be used in a joint J with the first end 11 having been thermoformed into the bell end 2 once the gasket (not shown) and other elements, such as caulking, are introduced to the bell end 2.

Before the pipe 4 is pushed onto the mandrel 40, as illustrated in FIGS. 10A, 10B and 10C, it is preferred that the pipe 4 is heated in order to improve the elasticity of the pipe 4. It is also understood that in one preferred embodiment, the pipe 4 is made of PVC and will generally be warm when it is extruded. Because of this, it is preferred to maintain the heat of the pipe 4 from the extrusion process for as long as possible and to perform the thermoforming of the bell end 2 soon after the pipe 4 is extruded.

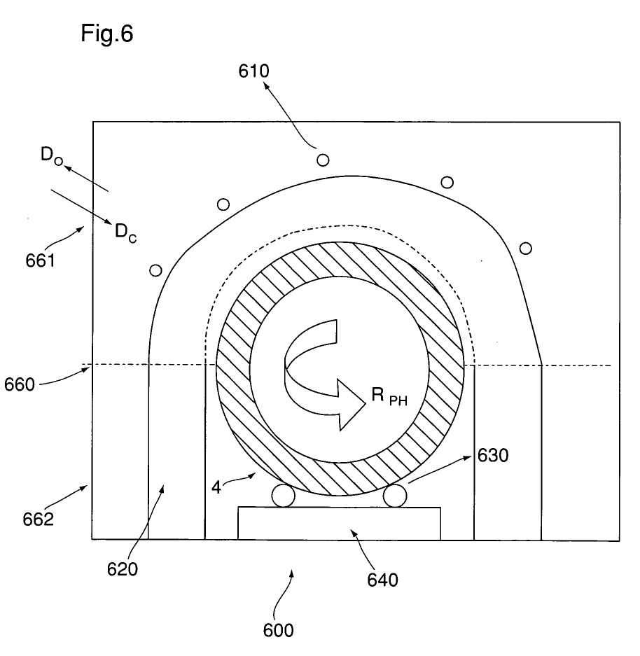

To accomplish this, a preheater, as shown generally by reference numeral 600 in FIG. 6, may be used. The preheater 600 is generally located at the end of the conveyer 640 of the extruding machine (not shown) from which the pipe 4 is extruded. Therefore, the end 11 of the pipe 4 may be heated in the preheater 600 immediately after the pipe has been extruded and while the other portion of the pipe 4 is being cooled. As illustrated in FIG. 6, the preheater 600 has heating rods 610 located along the upper circumference of the pipe 4. The heating rods 610 are oriented parallel to the longitudinal axis L_{A}. The heating rods 610 will have an effective heating length which preferably coincides at least with the position of the pipe 4, which will be pushed onto the second portion L_{M2} and transition phase L_{MT} of the mandrel 40 to form the transition phase L_{T} and second portion L₂ of the pipe B. To evenly preheat the pipe 4, the pipe 4 can rotate in direction R_{PH} on rollers 630 which may be integrally formed with the conveyor 640. Curtains 620 provide insulation between the external atmosphere and the heating rods 610 inside the preheater 600.

Because the pipe 4 is on the conveyor 640 from the extruder, the preheater 600 may have a hinge, shown by reference numeral 660, upon which the upper portion 661 located above the dot-dash line 660 may rotate with respect to the lower portion 662 to facilitate insertion and removal of the pipe 4. In this way, the upper portion 661 may move upward in the direction Do to an open position (not shown) to permit insertion of the pipe 4 and then rotate downward in the direction D_{C} to the closed position shown in FIG. 6. In this way, the preheater 600 can be moved into place around the pipe 4 without the pipe 4 being removed from the conveyer 640 used to extrude the pipe 4 thereby improving the efficiency of the system and also retaining in the pipe 4 as much heat as possible from the extrusion process. Furthermore, while the first end 11 of the pipe 4 is in the preheater 600, the other parts of the pipe 4 will be cooling from the extrusion process permitting easier transportation of the pipe 4 from the conveyor 640.

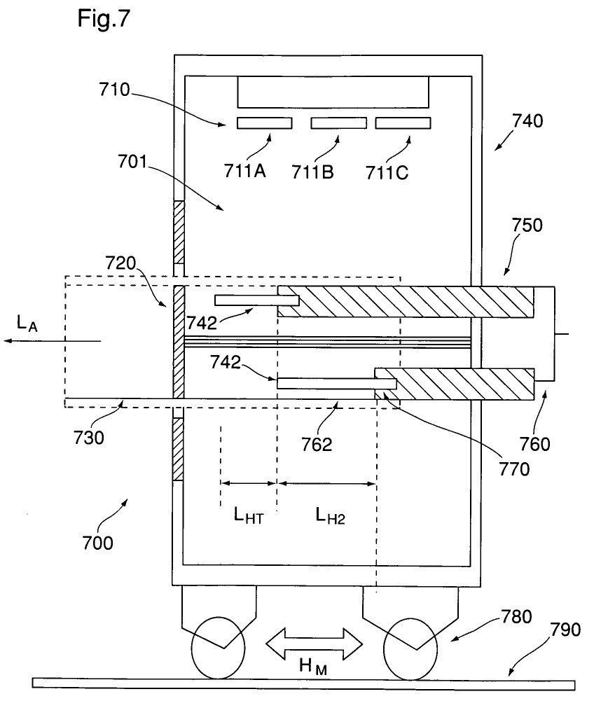

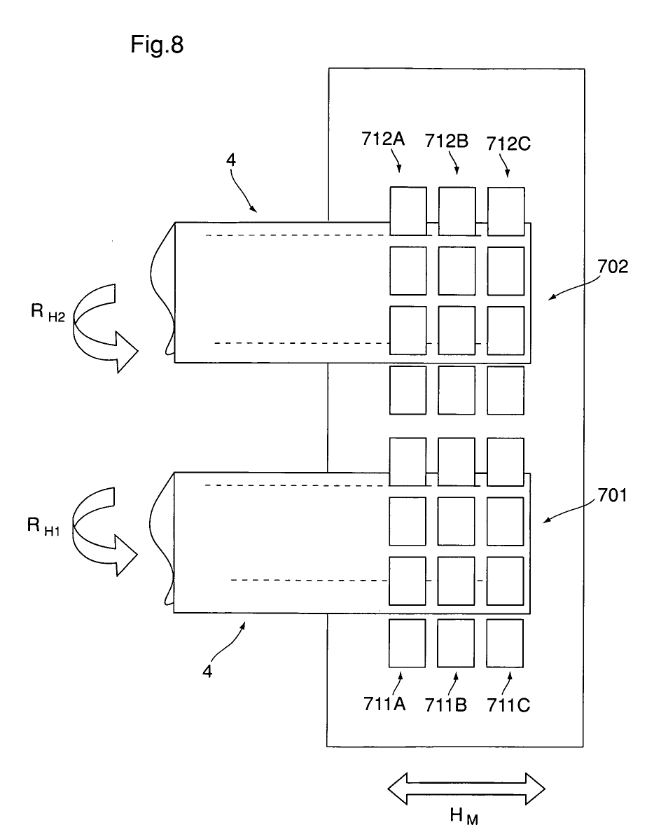

After the preheater 600, the pipe 4 is preferably inserted into a heating box, as shown generally as reference numeral 700 in FIG. 7. The heating box 700 may have a first zone 701 and optionally may have a second zone 702 as shown in FIG. 8, which is a top view of the heating box 700. The first zone 701 and second zone 702 may be used to heat two different pipes 4 simultaneously and/or to move the same pipe 4 from the first heating zone 701 to the second heating zone 702 to provide heating at different rates and at different temperatures.

Each zone 701, 702 have top heaters 710. The top heaters 710 in each zone 701, 702 consist of twelve heating plates which measure 8″×8″ in dimension and consume up to 1,200 W of electrical energy each. The twelve heating plates 710 are arranged in three rows, 711A, 711B and 711C in the first zone 701 and three rows 712A, 712B and 712C in the second zone 702. The heating plates 710 heat the outside of the pipe 4. The temperature of each row 711A, 711B, 711C, 712A, 712B and 712C can be controlled independently. In a preferred case, the respective temperatures of each row 711A, 711B and 711C in the first zone 701 are about 980° F., 1060° F. and 130° F., respectively, and, the respective temperatures of each row 712A, 712B and 712C in the second zone 702 are 740° F., 1060° F. and 1300° F., respectively.

In addition to the top heater 710, the heating box 700 also comprises a plurality of pin heaters, as shown generally by reference numeral 742. The pin heaters 742 are arranged inside the pipe 4 when the first end 11 of the pipe 4 is inserted into an inserted position in the heating box 700 as illustrated by dashed lines in FIG. 7 and solid lines in FIG. 8.

As illustrated in FIGS. 7 and 9, the plurality of heating rods 742 have different configurations. In particular, the plurality of heating rods 742 comprise, in a preferred embodiment, at least one extended heating rod having dimensions of ¾″×6″ long and power output of 550 W with an effective heating length 752 of 4.5″. This extended heating rod, identified by reference numeral 750 in FIGS. 7 and 9, has the effective length 752 much further in the pipe 4 than the effective length 762 of the other rods 760. In particular, as illustrated in FIG. 7, the extended rod 750 has a transition effective heating length 752 which is at a longitudinal position L_{HT} in the heating box 700. When the pipe 4 is inserted into the inserted position in the heating box 700, the longitudinal position L_{HT} of the transition effective heating length 752 of the extended rod 750, will correspond with the portion of the first end 11 of the pipe 4 which will fit over the transition phase 63 of the mandrel 40 when the pipe 4 is pushed onto the mandrel 40 to form the transition phase L_{T} of the bell end 2. In this way, the extended rod 750 provides heating of the pipe 4 at a longitudinal position L_{T} of the pipe 4 where the transition L_{T} phase will be formed in the bell end 2. This longitudinal position L_{HT} of the effective length 752 of the extended heating rod 752 also corresponds to the longitudinal position L_{MT} of the sloped portion 63 of the working surface 60 when the pipe 4 is pushed onto the mandrel 40.

The other rods 760 of the plurality of rods 740 may be 18″ in length and each may have a second portion effective heating length of 9″, as shown generally by reference numeral 762, to heat the pipe 4 at the longitudinal position L_{H2} correspond to the second portion L₂ of the pipe 4, when the pipe 4 is in the inserted position in the headers 701, 702. The heating rod 760 will generally be ¾″×12″ long and have an output of up to 2,000 W to heat the portion of the first end 11 that will fit over the second portion 62 of the working surface 60 of the mandrel 40 and form the second portion L₂ of the bell end 2.

It has been appreciated that adding the extended rod 750 with the effective length 752 coinciding with the portion of the pipe 4 which will fit over the sloped portion 63 of the mandrel 40 and eventually form the transition phase L_{T} of the bell end 2 facilitates formation of a transition angle α at the transition phase L_{T} of the pipe 4 which is greater than 35°. It is also noted from FIG. 7 that the transition effective heating length 752 of the extended heating rod 750 commences at a longitudinal position L_{HT} which corresponds to the end of the second portion effective heating length 762 of the other rods 760. In this way, additional heating of the pipe 4 is possible at a deeper longitudinal position corresponding to the longitudinal position L_{H1} without overheating the first end 11 of the pipe 4 corresponding to the longitudinal position L_{HT}. It is apparent that overheating of the pipe 4, which can also be apparent from a discolouration of the plastic, may damage the plastics used in the pipe 4 severely affecting its usefulness. Furthermore, as illustrated in FIG. 8, it is understood that the pipe 4 will be rotated about its axis L_{A} when inserted into the inserted position of the first and second zones 701, 702 of the heating box 700 as illustrated by arrows R_{H1} and R_{H2} in FIG. 8. This permits more even heating of the pipe 4 and avoids overheating.

In general, the heating rods 750, 760 will not be heated to a particular temperature, but rather the temperature of the effective length 752, 762 of the rods 750, 760 will be controlled by controlling the percentage of power applied to the rods 742. In a preferred embodiment, the pipe 4 is 18″ DR25 and the power usage of the rods 742 is about 50% of the full capacity. It is understood that a person skilled in the art may modify these temperatures for different thickness of pipes so as to obtain the proper heating of the pipe 4 without burning or permanently damaging the pipe 4.

As indicated above, the first end 11 will be initially placed into the preheater 600 shortly after extrusion. This can be done for about 10 to 20 seconds depending on the extrusion process. The first end 11 is then placed in the first heating zone 701 in the heating block 700 for about 640 seconds and then may be placed in the second heating zone 702 for a further 640 seconds. The first end 11 will then be placed on the mandrel 40, and the process described above will take place to form the bell end 7. The time for heating the first end 11 in the preheater 600 and the heating box 700 will be selected to substantially correspond to the time required to extrude another length of pipe 4. Therefore, after this combined amount of time to thermoform a bell end 2 on a length of pipe 4, a further length of pipe 4 will have been extruded by the extrusion machine (not shown). Therefore, in general, the time required to extrude a length of pipe 4 substantially corresponds to the total time required to preheat the first end 11 in the preheater 600, heat the first end 11 in the heating box 700 as well as the time required to push the first end 11 onto the mandrel 400, conform the first end 11 to the working first surface 60 of the mandrel 40 by cooling the first end 11, and strip the first end 11 from the mandrel 40. This provides an efficient process for continuously forming lengths of pipe having a bell end 2.

To allow the pipes to be moved easily between the heating zones 701, 702, the heating box 700 has wheels 780 which may move on a track 790. The wheels permit the heating box 700 shown in FIG. 8 to move in the direction H_{M} which is aligned with the longitudinal axis L_{A} to allow the first end 11 of the pipe 4 to be inserted into the first zone 701 and the second zone 702 of the heating box 700.

After the heating process, the first end 11 of the pipe, and more preferably the longitudinal position where the transition phase L_{T} will be formed, will have an average temperature of preferably at least 100° F., more preferably 200° F. and still more preferably 300° F. It has been found that heating the pipe 4 to have these preferred temperatures will facilitate movement of the first end 11 of the pipe 4 onto the working surface 60 of the mandrel 40 having a sloped portion 63 with a forming angle β of more than 35°. In this way, the bell end 2 can be formed with the transition phase L_{T} having a transition angle α greater than 35° with respect to the longitudinal axis L_{A}. However, it will be understood that these preferred temperatures are not precise temperatures but rather may vary by +/−10%, and, it is also understood these preferred temperatures may also vary with the diameter and/or thickness of the pipe 4.

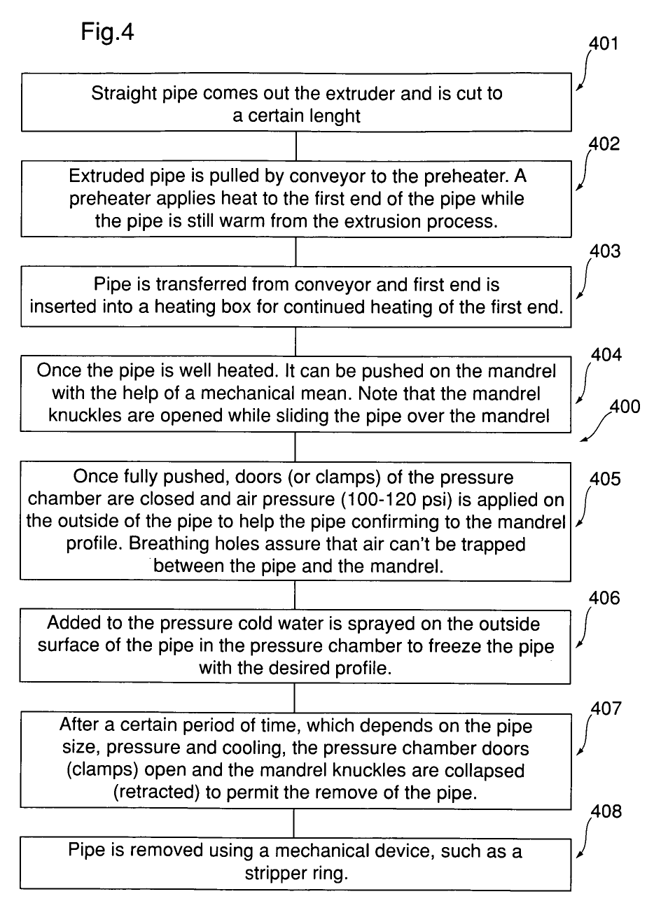

FIG. 4 illustrates a flow chart outlining the various steps in the process for thermoforming a bell end 2 in an extruded thermoplastic pipe 4 with the bell end 2 having a transition angle α that transition phase L_{T} of greater than 35° with respect to a longitudinal axis L_{A} of the pipe 4. As illustrated in FIG. 4, the first step 401 comprises extruding a straight pipe from an extruder (not shown) which pipe 4 is cut to a certain length. Then in step 402, the extruded pipe 4 is pulled by the conveyor 640 to the preheater 600. The preheater 600 applies heat to the first end 11 of the pipe 4 while the pipe 4 is still warm from the extrusion process and the other portion of the pipe 4 is cooling from the extrusion process so it can be more easily transferred from the conveyor 640. In step 403, the pipe 4 is transferred from the conveyor 640 and the first end 11 is inserted into a heating box 700 for continued heating of the first end 11. In cases where the heating box 700 has a first zone 701 and a second zone 702, the first end 11 will be removed from the first zone 701 and inserted into the second zone 702 after heating in the first zone 701.

At step 404, once the first end 11 of pipe 4 is well heated, the first end 11 of pipe 4 can be pushed onto the mandrel 40 with the help of mechanical means (not shown). It is preferred that the mandrel knuckles are retractable knuckles 44 which are in the opened or extended position while the first end 11 of pipe 4 is pushed onto the mandrel 40. At step 405, once the first end 11 of pipe 4 has been fully pushed onto the mandrel 40, doors or clamps 47 of a pressure chamber 46 are closed and a pressure that is applied to the outside of the first end 11 of pipe 4 to help conform the first end 11 of pipe 4 to the working surface 60 of the mandrel 40. Preferably, the pressure applied is about 100 to 120 pounds per square inch (PSI). As indicated above, breathing holes 42 preferably located at the sloped portion 63 of the working surface 60 assure that air cannot be trapped between the first end 11 of pipe 4 and the mandrel 40. In a preferred embodiment, in addition to the pressure, cold water 49 may be sprayed onto the outside surface of the first end 11 of pipe 4 while in the pressure chamber 46 to cool off the first end 11 of pipe 4 and “freeze” the first end 11 of pipe 4 with the desired profile corresponding to the working surface 60 of the mandrel 40.

As shown in step 407 after a certain period of time, which will depend on the size of the pipe 4, the pressure applied at step 405 in the cooling procedure, the pressure chamber doors or clamps 47 are open and the retractable mandrel knuckles 44 are collapsed or retracted to permit the removal of the first end 11 of pipe 4 from the mandrel 40. In step 408, the first end 11 of pipe 4 is removed using a mechanical device, such as a stripper ring 48.

Accordingly, using the above method, an extruded pipe thermoplastic pipe 4 having a transition angle α at the transition phase L_{T} greater than 35° may be formed. In the preferred embodiment, the extruded pipe 4 will be thermoformed using this process to form a transition angle α at the transition phase L_{T} greater than 45°, and more preferably greater than 55° and still more preferably about 60°.

To the extent that a patentee may act as its own lexicographer under applicable law, it is hereby further directed that all words appearing in the claims section, except for the above defined words, shall take on their ordinary, plain and accustomed meanings (as generally evidenced, inter alia, by dictionaries and/or technical lexicons), and shall not be considered to be specially defined in this specification. Notwithstanding this limitation on the inference of “special definitions,” the specification may be used to evidence the appropriate ordinary, plain and accustomed meanings (as generally evidenced, inter alia, by dictionaries and/or technical lexicons), in the situation where a word or term used in the claims has more than one pre-established meaning and the specification is helpful in choosing between the alternatives.”

It will be understood that, although various features of the invention have been described with respect to one or another of the embodiments of the invention, the various features and embodiments of the invention may be combined or used in conjunction with other features and embodiments of the invention as described and illustrated herein.

Although this disclosure has described and illustrated certain preferred embodiments of the invention, it is to be understood that the invention is not restricted to these particular embodiments. Rather, the invention includes all embodiments, which are functional, electrical or mechanical equivalents of the specific embodiments and features that have been described and illustrated herein.

The embodiments of the invention in which an exclusive property or privilege is claimed are defined as follows:

1. A process for thermoforming a bell end in an extruded thermoplastic pipe, said bell end having a transition angle at a transition phase of greater than 35° with respect to a longitudinal axis of the pipe, said process comprising:
heating a first end of the extruded pipe;
after heating, pushing the first end onto a mandrel, said mandrel extending along a longitudinal axis and having a working surface, said working surface having a first portion with an outer diameter corresponding to the inner diameter of the extruded pipe, a second portion having an outer diameter corresponding to the outer diameter of the extruded pipe, and a sloped portion intermediate the first portion and the second portion, said slope portion having at least one forming angle greater than 35°, said first end being initially pushed onto the first portion;
after the first end has been fully pushed onto the mandrel, conforming the first end to the working surface of the mandrel; and
after the first end has been cooled, removing the first end from the mandrel.

2. The process as defined in claim 1, wherein the heating step comprises:
inserting the first end to an inserted position in a heating box, said heating box having a plurality of heating rods, each rod having an effective heating length, at least one of the heating rods having a transition effective heating length which, when the first end is in the inserted position, extends along the first end corresponding to a longitudinal position of the pipe where the transition phase will be formed.

3. The process as defined in claim 2, wherein at least one of the plurality of heating rods comprise a subset of heating rods having a second portion effective heating length which extends along at least a portion of the first end of the pipe which will extend over the second portion of the mandrel when the first end is pushed onto the mandrel.

4. The process as defined in claim 3 further comprising:
while the first end is still warm from extrusion, preheating the first end in a pre-heater.

5. The process as defined in claim 4 wherein the pre-heater has a plurality of heating rods which heat an exterior surface of the pipe and wherein the plurality of rods of the heating zone are located inside the first end and heat the interior of the pipe.

6. The process as defined in claim 4, wherein the heating box has a first zone and a second zone, and the heating process comprises heating the first end in the first heating zone and then heating the first end in the second zone.

7. The process as defined in claim 4 wherein the time required to extrude a length of pipe substantially corresponds to the total time required to preheat the first end, heat the first end in the heating zone, push the first end onto the mandrel, conform the first end to the working surface of the mandrel, cool the first end and remove the first end from the mandrel.

8. The process as defined in claim 1 wherein the step of conforming the first end to the working surface of the mandrel comprises applying pressure to an outer surface of the first end.

9. The process as defined in claim, 8 wherein the step of applying pressure comprises applying air pressure greater than 100 psi.

10. The process as defined in claim 8, wherein once pressure has been applied for a period of time, spraying water onto the outer surface of the first end to freeze the extruded pipe to a profile substantially corresponding to the working surface of the mandrel.

11. The process as defined in claim 1, wherein the at least one forming angle is greater than 45° with respect to the longitudinal axis.

12. The process as defined in claim 11, wherein the at least one forming angle is greater than 55° with respect to the longitudinal axis.

13. The process as defined in claim 12, wherein the at least one forming angle is about 60° with respect to the longitudinal axis.

14. The process as defined in claim 12, wherein the at least one forming angle is no greater than 90° with respect to the longitudinal axis.

15. The process as defined in claim 1, wherein the mandrel further comprises circumferential breathing holes located around the circumference of the mandrel at a longitudinal position corresponding to the intersection of the sloped surface and the first portion.

16. The process as defined in claim 15, wherein the sloped portion intersects the first portion at a first longitudinal position along the longitudinal axis of the mandrel and the sloped portion intersects the second portion at a second longitudinal position along the longitudinal axis of the mandrel, and wherein the sloped portion is sloped with respect to the longitudinal axis at the at least one forming angle from the first longitudinal position to the second longitudinal position.

17. The process as defined in claim 16, wherein the circumferential breathing holes are located near the first longitudinal position.

18. The process as defined in claim 17, wherein the circumferential breathing holes facilitate removal of trapped air during the step of applying pressure.

19. The process as defined in claim 18, wherein the circumferential breathing holes communicate with the atmosphere.

20. The process defined in claim 1, wherein the second portion of the mandrel comprises retractable knuckles; and wherein the step of removing the first end from the mandrel includes retracting the knuckles of the mandrel after the first end has been cooled.

21. An extruded pipe having a transition angle at the transition phase greater than 35° formed by the process defined in claim 1.

22. An extruded pipe having a transition angle at the transition phase greater than 35° formed by the process defined in claim 2.

23. An extruded pipe having a transition angle at the transition phase greater than 35° formed by the process defined in claim 15.

24. A process for thermoforming a bell end with a transition phase of greater than 35° in an extruded thermoplastic pipe having a length, said process comprising:
heating a first end of the extruded pipe;
after heating, pushing the first end onto a mandrel in a first direction, said mandrel extending along a longitudinal axis and having a working surface with at least one forming angle greater than 35° with respect to the longitudinal axis and increasing an outer diameter of the mandrel in the first direction;
after the first end has been fully pushed onto the mandrel, applying pressure to an outer surface of the first end to conform the first end to the working surface of the mandrel; and
after cooling of the first end, removing the first end from the mandrel.

25. A process as defined in claim 24, wherein the heating step comprises:
preheating the first end in a pre-heater having heating rods with effective heating lengths, which will extend over the second portion of the mandrel when the first end is pushed onto the mandrel; and
inserting the first end to an inserted position in a heating box having a plurality of heating rods, each rod having an effective heating length, at least one of the rods having a transition effective heating length which extends along the first end corresponding to the longitudinal position where the transition phase will be formed when the first end is in the inserted position in the heating box.

26. The process as defined in claim 1 wherein the heating step heats the first end corresponding to the longitudinal position where the transition phase will be formed to at least an average temperature of 100° F.

27. The process as defined in claim 1 wherein the heating step heats the first end corresponding to the longitudinal position where the transition phase will be formed to at least an average temperature of 200° F.

28. The process as defined in claim 1 wherein the heating step heats the first end corresponding to the longitudinal position where the transition phase will be formed to at least an average temperature of 300° F.

29. The process as defined in claim 3 wherein the transition effective heating length is longitudinally separate from the second portion effective heating length.

30. The process as defined in claim 3 wherein the transition effective heating length of the at least one extended heating rod commences at a longitudinal position along the pipe corresponding to the end of the second portion effective heating length.
